(19) United States
(12) Patent Application Publication
(10) Pub. No.: US 2013/0007843 A1
(43) Pub. Date: Jan. 3, 2013

(54) Method, Program Product, and System of Network Connection in a Wireless Local Area Network

(75) Inventors: Keven Cheng, Taipei (TW); Yao-Huan Chung, Taipei (TW); Ko-Chen Tan, Taipei (TW); Wen-Chiao Wu, Taipei (TW); Chia-Yen Wu, Taipei (TW)

(73) Assignee: INTERNATIONAL BUSINESS MACHINES CORPORATION, Armonk, NY (US)

(21) Appl. No.: 13/528,035

(22) Filed: Jun. 20, 2012

(30) Foreign Application Priority Data
Jun. 30, 2011 (TW) 100123030

(51) Int. Cl. G06F 21/20

(52) U.S. Cl. 726/3

(57) ABSTRACT

Disclosed is a method of network connection in a wireless local area network. The wireless local area network comprises a client, an access point, and an authentication database coupled to the access point. The authentication database comprises a plurality of collections of data entries, wherein each of the collections of data entries comprises a plurality of data entries. The network connection method comprises: passing messages containing queries relating to data entries in the authentication database and receiving responsive answer tags.

### BACKGROUND OF THE INVENTION

This application is based on and claims the benefit of priority from Taiwan Patent Application 100123030, filed on Jun. 30, 2011.

### FIELD OF THE INVENTION

The present invention relates to wireless local area networks (WLANs), and more particularly, to prevention of unauthorized intrusion into an access point or a wireless client in a WLAN.

### DESCRIPTION OF THE PRIOR ART

Early computers usually communicate with each other with a wired local area network (LAN). However, due to the wide use of mobile devices (such as mobile phones, notebook computers, and personal digital assistants (PDAs)), WLANs have evolved into one of the major ways of communication between computers. WLANs effectuate communication by means of various wireless media, such as radio signals and infrared signals.

Recent years see the rapid and across-the-board growth of portable computing. In addition to wire connection, portable computing relies heavily on a backbone network and a connected WLAN in order to access various network resources.

Among a wide variety of WLANs, IEEE 802.11 (also known as WiFi) is in wide and intensive use. IEEE 802.11b,g,n adopt an ISM (Industrial, Scientific, Medical) frequency band that ranges between 2,400 MHz and 2,483.5 MHz. The ISM frequency band is applicable to a spread spectrum system worldwide without requiring a permit.

FIG. 1 is a schematic view of WLAN authentication of IEEE 802.11 according to the prior art. To start using a wireless local area network (WLAN), a mobile device has to perform message-based communication in three stages, namely probe request 160/probe response 164, authentication request 167/authentication response 172, and association request 176/association response 180, in their order of occurrence in time. The three stages of message-based communication are regulated by IEEE 802.11.

In the WLAN, a wireless client typically accesses, via an access point, resources available on a backbone network. The backbone network is usually a cable network (such as Ethernet), another wireless network, or a combination thereof. When an access point enables access to the resources available on a cable network, the access point includes at least a cable network interface, a bridge function, and a wireless network interface, so as to performing traffic bridging between a wireless network and the cable network.

Due to the wide use of WLANs, network security is a concern that is becoming more important. A WLAN effectuates data transmission by means of radio waves. That is to say, any wireless client within a service area covered by an access point can send data to the access point or receive data from the access point. Conventional WLANs enhance user security by means of service set identifiers (SSID), open or shared key identity authentication, Wired Equivalent Privacy (WEP) keys, media access control (MAC), Wi-Fi Protected Access (WPA), etc.

Compared with a wired local area network, although WLANs manifest greater mobility to users, WLANs attach great importance to communication security. These features of WLANs are especially important, considering that communication security-related issues are absent from the field of wired local area networks.

For instance, in general, after locating an access point, a wireless client stores its SSID and security (such as WEP or WPA) configuration setting in the wireless configuration of the wireless client. Once the wireless client is connected to the access point again, a wireless device of the wireless client will be automatically connected to the access point.

However, if a fake access point (fake AP) or a spy access point (spy AP) is in the vicinity of the wireless client and has the same SSID and security configuration setting, or if the spy access point adjusts its wireless connection intensity, the wireless client will be likely to be automatically connected to the spy access point and have its data stolen.

For example, a hacker can create several fake and spy access points and disguise them as legal hotspots accessible to the general public. The hacker can capture a user's hotspot logging information (username, password, etc.) and other sensitive information, or access the user's shared folders as soon as the user gets connected to the fake and spy access points.

Hence, what offers a new challenge is about providing a way of maintaining high mobility of WLAN users and still preventing a fake and spy network apparatus from stealing a user's confidential data so as to attain a safe WLAN environment.

### SUMMARY OF THE INVENTION

An aspect of the present invention is to provide an authentication method based on a puzzle/answer mechanism for efficiently preventing a fake network apparatus from stealing a user's confidential data so as to attain a safe WLAN environment.

Another aspect of the present invention is to provide security-enhancing technology applicable to a wireless local area network (WLAN) in blocking a fake access point/client or a spy access point/client by means of a puzzle/answer protocol, wherein its client and authentication database each have a collection of data entries for enhancing the security of connection between the client and the access point.

Yet another aspect of the present invention is to provide novel network connection authentication technology whereby each client has its own collection of data entries for communicating and negotiating with an authentication database, wherein the data entries will be deleted from the authentication database when used, so as to prevent unauthorized connection and intrusion effectively.

An embodiment of the present invention provides a network connection method for use in a wireless local area network (WLAN). The WLAN comprises a client, an access point, and an authentication database coupled to the access point, the authentication database comprising a plurality of collections of data entries. Each of the collections of data entries comprises a plurality of data entries. The network connection method comprises the steps of: receiving by the client one of the collections of data entries in the authentication database; sending a first message carrying an identification tag from the client to the access point; receiving by the access point a second message carrying a query tag, the second message being provided by the authentication database, the query tag being associated with a puzzle, the puzzle being associated with a first data entry of one of the collections of data entries, wherein a first answer to the puzzle is stored in the authentication database and comprises the first data entry; sending a third message carrying the query tag from the access point to the client, the query tag being associated with the puzzle; sending a fourth message carrying an answer tag from the client to the access point and the authentication database, the answer tag being associated with a second answer; and comparing and determining, by the authentication database, whether the first answer and the second answer match, so as to yield a comparison result.

Before the access point receives the second message, the network connection method further comprises sending a message carrying a puzzle request tag from the access point to the authentication database, so as to request the second message. After the client has sent the fourth message, the network connection method further comprises the steps of: sending a message carrying a compare tag from the access point to the authentication database, so as to compare and determine whether the first answer and the second answer match; and sending the comparison result from the authentication database to the access point.

The query tag and the answer tag are embedded in an authentication frame. The authentication frame has an authentication header. The authentication header has a frame body field that contains the query tag and the answer tag. The first message comprises a client's MAC address and a tag for authenticating a puzzle/answer protocol in use. The second message comprises a client's MAC address and an access point's MAC address. The third message comprises a client's MAC address. The fourth message comprises a client's MAC address.

Another embodiment of the present invention provides a computer program product comprising a computer executable procedure step. The computer executable procedure performs network connection in a wireless local area network (WLAN). The WLAN comprises a client, an access point, and an authentication database coupled to the access point. The computer executable procedure step comprises a procedure step for executing the aforesaid method.

Another embodiment of the present invention provides a client for accessing an access point in a wireless local area network (WLAN). The WLAN comprises the access point, an authentication database coupled to the access point and comprising a program memory for storing a procedure step for executing the aforesaid method, and a processor for executing the procedure step stored in the program memory.

Another embodiment of the present invention provides an access point accessible to a client in a wireless local area network (WLAN). The WLAN comprises a client, an authentication database coupled to the access point and comprising a program memory for storing a procedure step intended to execute the aforesaid method, and a processor for executing the procedure step stored in the program memory.

Another embodiment of the present invention provides a wireless local area network (WLAN) comprising a client, an access point, and an authentication database coupled to the access point, wherein the client, the access point, and the authentication database execute the aforesaid method.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a schematic view of authentication of a wireless local area network (WLAN) according to the prior art;

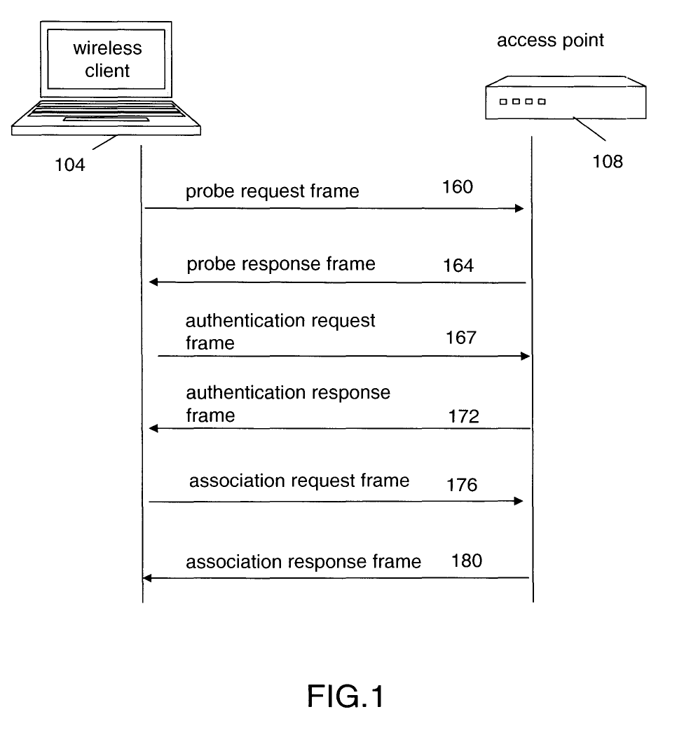

FIG. 2 is a schematic view of a system according to a specific embodiment of the present invention;

FIG. 3 is a schematic view of authentication of a wireless local area network (W LAN) according to a specific embodiment of the present invention;

FIG. 4 is a schematic view of success of an puzzle/answer transmitted between a wireless client, an access point, and an authentication database of a recipient server according to a preferred embodiment of the present invention;

FIG. 5 is a flowchart of receiving collections of data entries from an authentication database at a client according to a preferred embodiment of the present invention;

FIG. 6 is a flowchart of a network connection in a wireless local area network according to a preferred embodiment of the present invention;

FIG. 7 is a schematic view of a flowchart based on FIG. 5 and FIG. 6, showing that wireless clients each having separate collections of data entries for performing an enigmatic process according to a preferred embodiment of the present invention;

FIG. 8 is a flow chart of a state machine of a puzzle/answer mechanism according to a preferred embodiment of the present invention;

FIG. 9 is a schematic view of an example of the composition of an authentication frame complying with 802.11 protocol and an example of frame control fields in the authentication frame according to a preferred embodiment of the present invention;

FIG. 10 is a schematic view of communication between a client and an access point applicable to an authentication frame under 802.11 protocol according to a preferred embodiment of the present invention; and

FIG. 11 is a schematic view of how an access point authenticates the MAC address of each wireless client according to a preferred embodiment of the present invention.

### DETAILED DESCRIPTION OF THE PREFERRED EMBODIMENT

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a computer device, a method or a computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

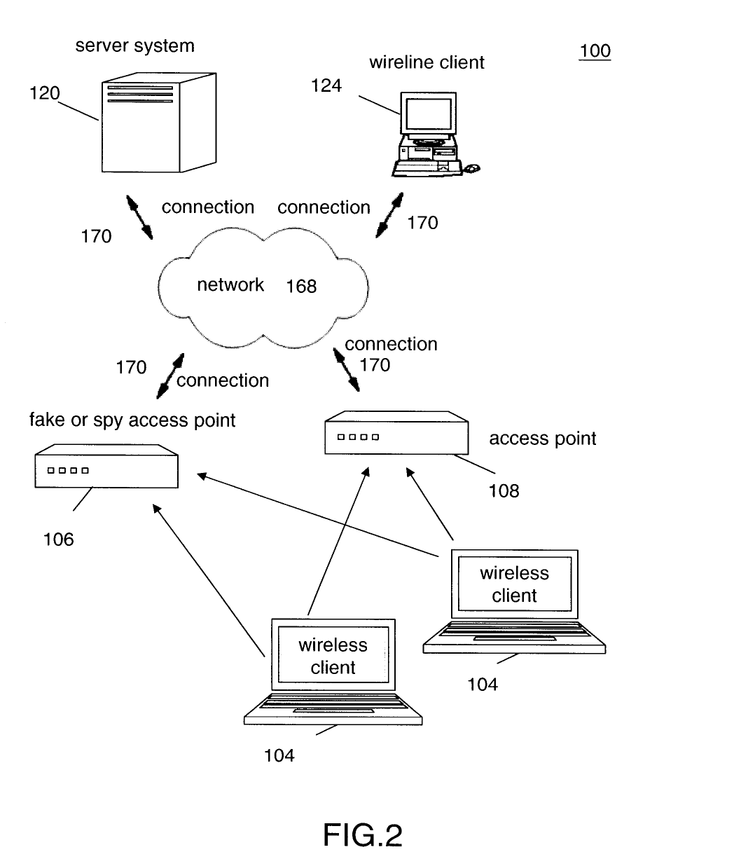

Referring to FIG. 2, there is shown a schematic view of a method, system, and product for use with a network connection in a wireless local area network according to a specific embodiment of the present invention. As shown in FIG. 2, a network system 100 comprises a network 168, a server 120, a plurality of authorized access points 108, and a plurality of wireless clients 104. The wireless clients 104 are each coupled to the network 168 via a connection 170, a wireless connection/wire connection, or both, so as to communicate with the access points 108 by, including but not limited to, a wireless means. Depending on the size and scope of an apparatus, the aforesaid devices come in different system types and different connection types. The wireless clients 104 are notebook computer systems, personal digital assistant (PDA) systems, mobile phones, smartphones, desktop computers, or other devices capable of accessing the network 168 by means of the authorized access points 108. FIG. 2 also shows that a plurality of wireline clients 124 usually communicates with the network 168 via a wire connection. The network system 100 further comprises access points and wireless clients other than the access points 108 and the wireless clients 104.

FIG. 2 also depicts an unauthorized fake or spy access point 106 disguised as a legal hotspot accessible to the general public. It is likely that the unauthorized fake or spy access point 106 is created by an individual or group when information technology management is kept in the dark about the unauthorized fake or spy access point 106 or gives no consent thereto. As mentioned earlier, the unauthorized fake or spy access point 106 is likely to adjust its own wireless connection intensity or have identical SSID and security configuration setting security; as a result, information related to a user is likely to be stolen as soon as the user gets connected to the access point 106, thereby compromising the security of WLAN environment.

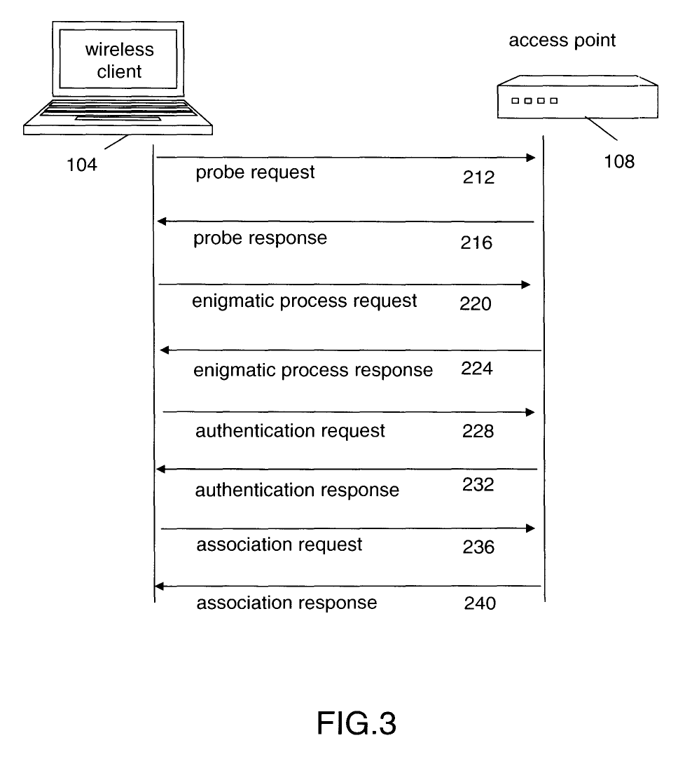

FIG. 3 is a schematic view of authentication of a wireless local area network according to a preferred embodiment of the present invention, wherein a frame communication process taking place between the wireless client 104 and the access point 108 is depicted. Referring to FIG. 3, to access the wireless local area network, the wireless client 104 in an environment sends a probe request (step 212). Afterward, the wireless client 104 detects the access point 108 by means of a probe response received by the wireless client 104 from the at least one said access point 108 (step 216). After receiving the probe response, the wireless client 104 sends an enigmatic process request (step 220) and then waits for an enigmatic process response from the access point 108 (step 224). The aforesaid enigmatic process request and enigmatic process response are described in detail later. After receiving the enigmatic response, the wireless client 104 communicates with the access point 108, using a message of authentication request (step 228). At this point in time, the wireless client 104 sends a password to the access point 108 for authentication and then waits for an authentication response from the access point 108 (step 232). After the authentication has passed, a link layer-based connection between the wireless client 104 and at least one of the access points 108 is created by means of an association request 236 and an association response 240. Afterward, the wireless client 104 has to pass authentication of the server 120, such as an AAA server (authentication, authorization, and accounting server), in order to gain more authority required for accessing network resources. In a preferred embodiment, the wireless client 104 sends to the access point 108 EAP-enabled information (Extensible Authentication Protocol-enable information) under Cross-border Network Extensible Authentication Protocol, and then the access point 108 sends the EAP-enabled information to the server 120 for authentication. After the authentication has passed, the server 120 sends a message to the access point 108 to inform the access point 108 of an EAP success in order to be authorized to receive and send a packet. The aforesaid probe request/probe response, authentication request/authentication response, association request/association response, authorization to access, and authorization to receive and send a packet, which take place between the wireless client 104 and the access point 108, are governed by IEEE 802.11 or understood by persons skilled in the art and thus are not reiterated herein for the sake of brevity.

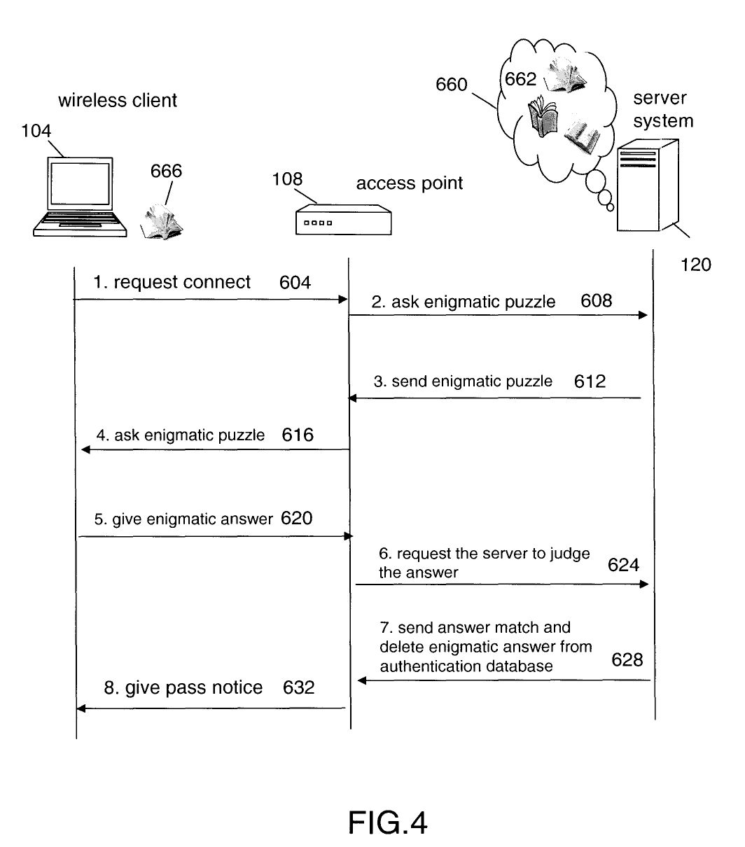

Referring to FIG. 4, there is shown a schematic view of the process flow of success of an enigmatic puzzle/answer received by a client 104 from an authentication database of the server 120 according to a preferred embodiment of the present invention, wherein the wireless local area network comprises a client 104, an access point 108, and a server 120. The server 120 has an authentication database 660. The authentication database 660 comprises a plurality of collections of data entries 662. Each of the collections of data entries 662 comprises a plurality of data entries 662. First, the client 104 fetches one of the collections of data entries 662 from the authentication database 660 and sets the fetched collection of data entries 662 to a collection of data entries 666 of the client 104; hence, the collections of data entries 666 of the client are identical to the collections of data entries 662 of the authentication database 660. Referring to FIG. 4, in step 604, the client 104 performs on the access point 108 a step of requesting connection. In step 608, the access point 108 performs on the server 120/authentication database 660 a step of asking an enigmatic puzzle. In step 612, the server 120/authentication database 660 performs on the access point 108 a step of sending an enigmatic puzzle. In step 616, the access point 108 performs on the client 104 a step of asking an enigmatic puzzle. In step 620, the client 104 performs on the access point 108 a step of giving an enigmatic answer. In step 624, the access point 108 performs on the server 120/authentication database 660 a step of requesting a server to judge an answer. In step 628, the server 120/authentication database 660 performs on the access point 108 a step of sending answer match and deleting an enigmatic answer from the server 120/authentication database 660. In step 632, the access point 108 performs on the client 104 a step of giving pass notice and sending answer match. The aforesaid acquisition of collections of data entries and enigmatic puzzle/answer process flow are described in detail later.

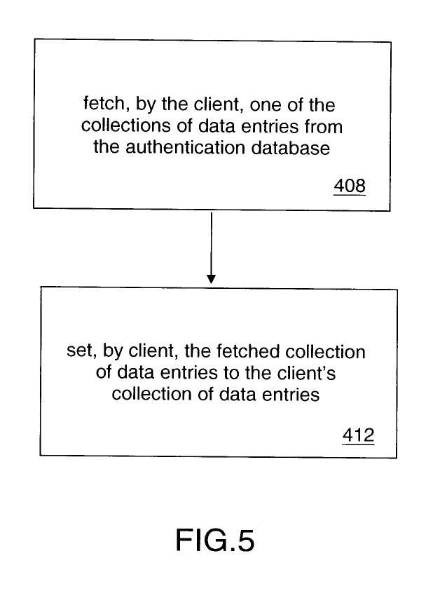

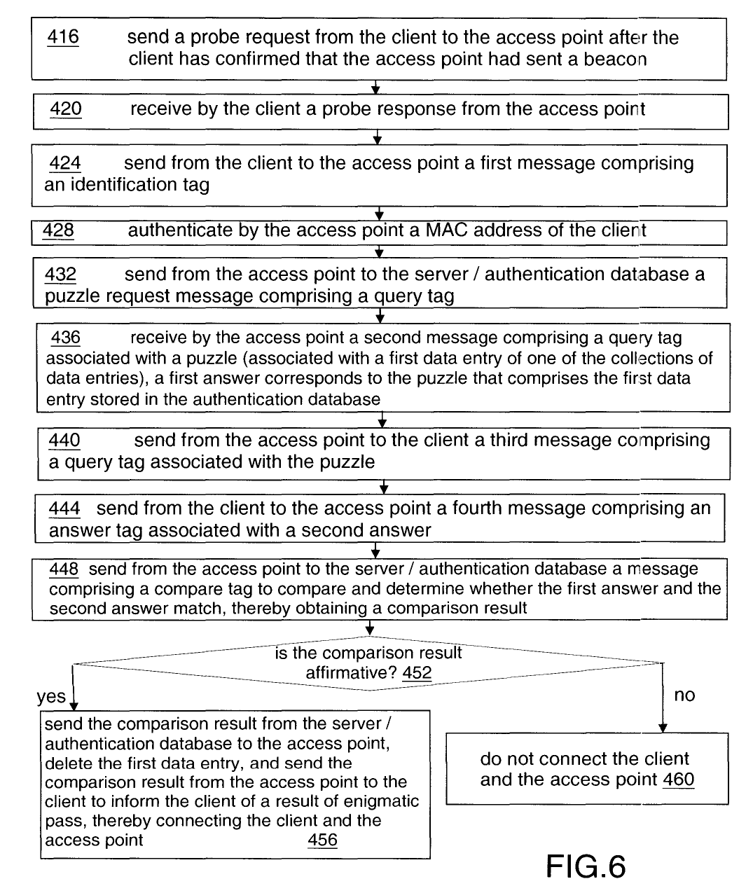

FIG. 5 is a flowchart of a method whereby a client receives collections of data entries from an authentication database according to a preferred embodiment of the present invention. FIG. 6 is a flowchart of a method of network connection in a wireless local area network according to a preferred embodiment of the present invention. The wireless local area network comprises the client 104, the access point 108, and the server 120. The server 120 has an authentication database 660. The authentication database 660 comprises a plurality of collections of data entries 662. Each of the collections of data entries 662 comprises a plurality of data entries 662. The server 120 is an authentication server. A network management server (not shown) is also coupled to the authentication server 120. Each of the access points 108 in the system controls the ability of the client 104 to access the Internet according to a command from the network management server. The main purpose of the authentication server 120 is to confirm the identity of the client 104 and grant access authority to the client 104. Furthermore, the authentication server 120 stores information related to the client 104 in a database. The aforesaid technology pertaining to the authentication server and the network management server is understood by persons skilled in the art and thus are not reiterated herein for the sake of brevity.

In a preferred embodiment of the present invention, a plurality of collections of data entries 662 is a plurality of books (or dictionaries, books, and a numeric string), whereas a plurality of data entries within collections of data entries 662 are words (words, characters, word blocks, sentences, sentence blocks, and numbers) in a composite book.

Referring to FIG. 4 and FIG. 5, in a preferred embodiment, the client 104 fetches one of the collections of data entries 662 from the authentication database 660 (step 408), and then the client 104 sets the fetched collection of data entries 662 to the client's collection of data entries 666 (step 412). Hence, the client's collections of data entries 666 are identical to the collections of data entries 662 in the authentication database 660. The client 104 can fetch the collections of data entries 662 from the authentication database 660 in whatever ways and at any time. For example, the authentication database 660 updates data of the client 104 automatically whenever the client 104 undertakes system installation or when data in a database of the client 104 is going to be used up.

FIG. 6 is a flowchart of a communication process between the wireless client 104 and the access point 108/server 120, using enigmatic process requests and enigmatic process responses, in a wireless local area network according to a preferred embodiment of the present invention. In this embodiment, the network connection is effectuated by means of the system 100 in FIG. 2.

Referring to FIG. 4, FIG. 5, and FIG. 6, in step 416, after confirming that the access point 108 has sent a beacon, the client 104 sends a probe request to the access point 108. In step 420, the client 104 receives a probe response from the access point 108. In step 424, the client 104 sends to the access point 108 a first message carrying an identification tag. In step 428, after the client 104 has sent the first message, the access point 108 authenticates a MAC address of the client 104.

In step 432, the access point 108 sends to the server 120/authentication database 660 a puzzle request message carrying a puzzle request tag. In step 436, the access point 108 receives a second message carrying a query tag, wherein the second message is provided by the server 120/authentication database 660. In a preferred embodiment, the query tag is associated with a puzzle, and the puzzle is associated with a first data entry of one of the collections of data entries. A first answer to the puzzle is stored in the authentication database 660 and includes the first data entry. The puzzle comprises an index or position of the first data entry in the collections of data entries.

In step 440, the access point 108 sends to the client 104 a third message carrying the query tag, and the query tag is associated with the puzzle. In step 444, the client 104 sends to the access point 108 a fourth message carrying an answer tag, and the answer tag is associated with a second answer. In step 448, the access point 108 sends to the server 120/authentication database 660 a message carrying a compare tag to compare and determine whether the first answer and the second answer match so as to yield a comparison result. In step 452, the server 120/authentication database 660 determines whether the comparison result is a match.

In step 456, if the comparison result is a match, the server 120/authentication database 660 will send the comparison result to the access point 108 and delete the first data entry from the server 120/authentication database 660; afterward, the access point 108 sends the comparison result to the client 104 to inform the client 104 of a result of an enigmatic pass, thereby connecting the client 104 and the access point 108. Upon completion of the aforesaid handshaking, the client 104 and the access point 108 start executing a connection procedure of IEEE 802.11.

In step 460, if the comparison result is not a match, the client and the access point will not be connected together. In a preferred embodiment, the Internet protocol address of a fake access point and a spy access point can be invalidated. For example, the client's MAC address is not found in an approval checklist, and a spy access point cannot judge the identification tag.

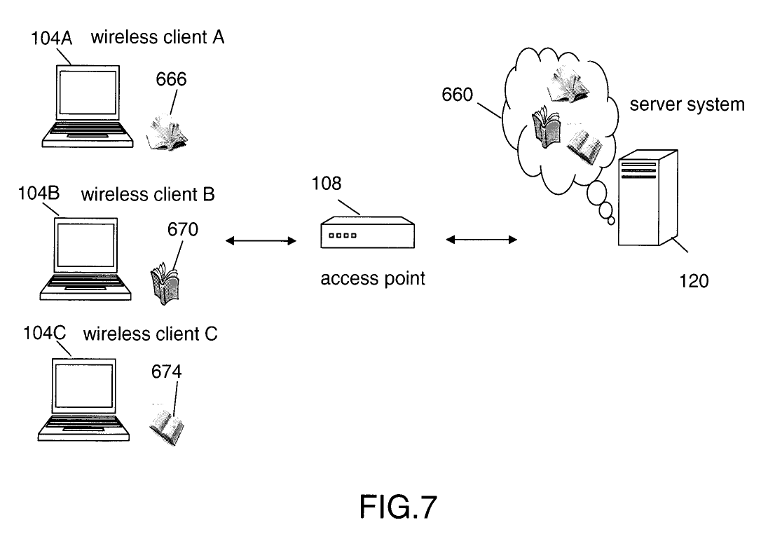

FIG. 7 is a flowchart based on FIG. 6 according to a preferred embodiment of the present invention, showing wireless clients 104A, 1048, 104C which have independent collections of data entries 666, 670, 674, respectively, wherein the independent collections of data entries 666, 670, 674 are provided by the server 120 to perform an enigmatic process. The independent collections of data entries are created according to the MAC address, whereas the independent collections of data entries are arranged by a system installation worker of the client 104. Alternatively, if the data in the database of the client 104 are going to be used up, the authentication database 660 will automatically update the data of the client 104 and maintain a specific size. The way of authenticating the MAC addresses of wireless clients by the access point is further described later.

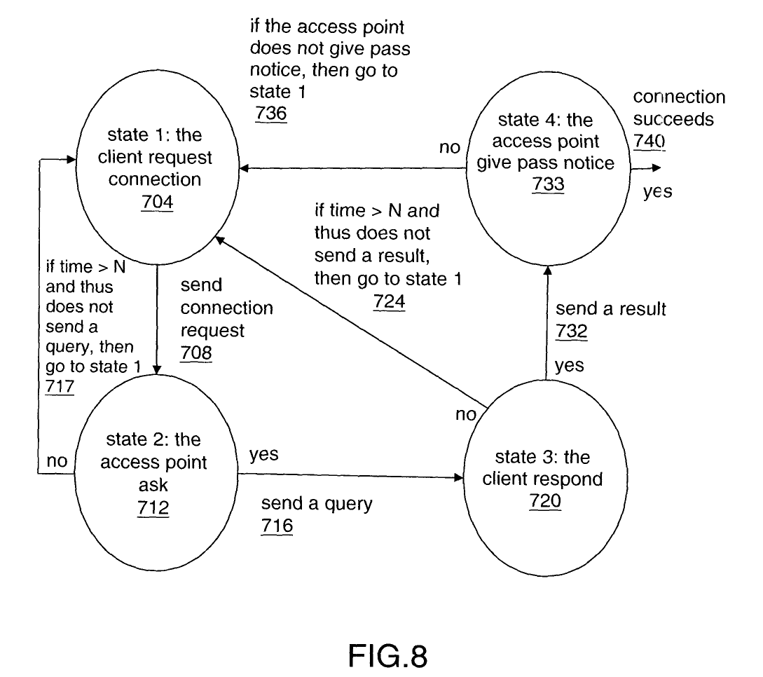

FIG. 8 is a flow chart of a state machine of a puzzle/answer mechanism according to a preferred embodiment of the present invention. Referring to FIG. 8, each state is described below. State 1 (704): a client requests connection (assertion) and sends a connection request (708). State 2 (712): an access point makes a query (challenge) and sends the query (716), wherein, if time>N (such as three cycles) and has not sent the query, then go to state 1 (717). State 3 (720): the client gives a response, wherein, if time>N (such as three cycles) and has not sent the response, then go to state 1 (724), otherwise send a result and go to state 4 (733). State 4 (733): the access point gives pass notice, wherein, if the access point sends the result, then connection succeeds (740), wherein, if the access point does not send the result, then go to state 1 (736).

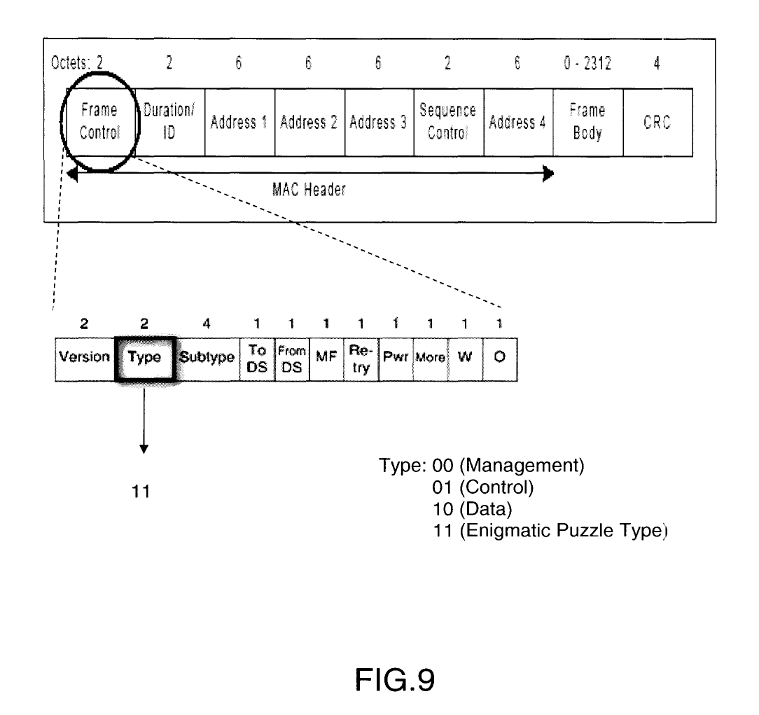

FIG. 9 is a schematic view of an example of the composition of an authentication frame complying with 802.11 protocol and an example of frame control fields in the authentication frame according to a preferred embodiment of the present invention. The authentication frame has a format specified in IEEE 802.11 and shown in FIG. 8, and comprises the following fields: Frame Control field, Duration field, Address 1, Address 2, Address 3, Sequence Control, Address 4, Frame Body, and CRC (cyclic redundancy check). Frame Control consists of the following fields: Protocol Version, Type, Subtype, To DS, From DS, More Flag, Retry, Power Management, More Data, WEP (Wired Equivalent Privacy), and Order. The aforesaid fields comply with proper values of IEEE 802.11 specifications. In this preferred embodiment, the Type field is configured to display binary numbers: 00 (Management), 01 (Control), 10 (Data), and 11 (these configuration values denote reserved fields under 802.11 protocol, and indicate an enigmatic puzzle type in this specific embodiment.)

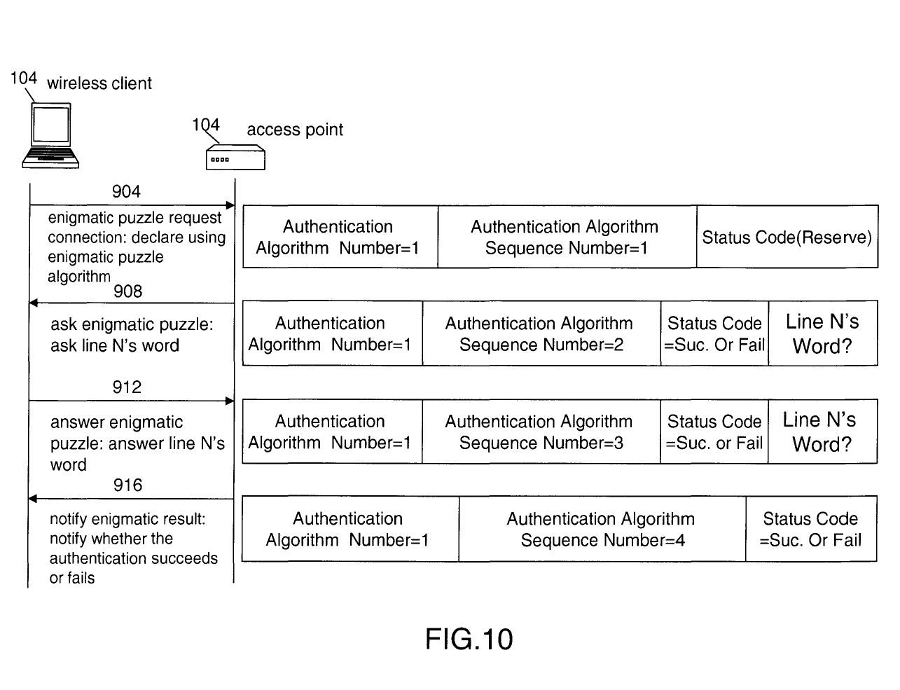

FIG. 10 is a schematic view of communication between a client and an access point applicable to an authentication frame under 802.11 protocol according to a preferred embodiment of the present invention, wherein the diagram illustrates authentication of the contents of a frame body. Step 904 involves declaring using an enigmatic puzzle algorithm in response to an enigmatic puzzle that requests connection. Step 908 involves asking line N's word in response to asking an enigmatic puzzle. Step 912 involves answering line N's word in response to answering an enigmatic puzzle. Step 916 involves responding that the authentication succeeds or fails in response to notifying an enigmatic result.

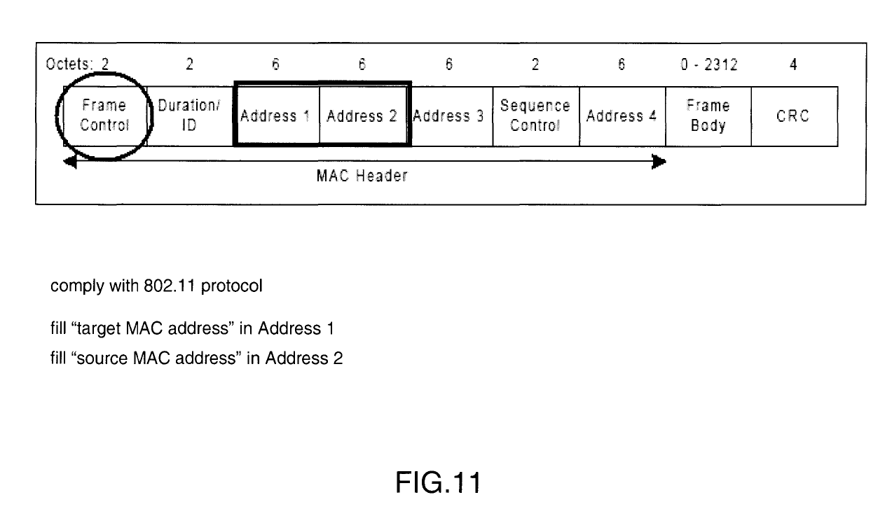

FIG. 11 is a schematic view of how an access point 108 authenticates the MAC address of each of the wireless clients 104 according to a preferred embodiment of the present invention. As shown in FIG. 11, under 802.11 protocol, Address 1 is filled with target MAC address, and Address 2 is filled with source MAC address. Hence, the access point 108 authenticates each of the wireless clients 104 by means of the mechanism of the aforesaid MAC addresses.

In the preferred embodiments of the present invention, regarding enigmatic authentication communication between a client and an access point, data entries in their collections of data entries 662 are deleted immediately after being used, and thus never repeat, so as to efficiently prevent fake and spy network apparatuses from stealing a user's confidential data according to the prior art. Furthermore, each client has an authentication database conducive to enhancement of security, even though the authentication database is of small dimensions. The present invention complies with the existing 802.11 protocol and thus is easy to implement. According to the present invention, confidential data are accessible to authorized clients and access points only, thereby providing a safe WLAN environment.

A point to note is that the present invention is not restrictive of the sequence of the steps illustrated with FIG. 3 through FIG. 6. What are illustrated with FIG. 3 through FIG. 6 are just different examples. Although a fake access point and a spy access point are illustrated with the drawings of the present invention, persons skilled in the art should be able to understand that fake clients and spy clients can be applied in the control of network security in the same way. Related details are not reiterated herein for the sake of brevity, as they are described herein when referring to the drawings of the present invention. Furthermore, clients, access points, and servers in the preferred embodiments of the present invention comply with IEEE 802.11 but are not necessarily so. In practice, various protocols are applicable to the present invention efficiently.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

What is claimed is:

1. A method of network connection in a wireless local area network, the wireless local area network comprising a client, an access point, and an authentication database coupled to the access point, the authentication database comprising a plurality of collections of data entries, wherein each of the collections of data entries comprises a plurality of data entries, the network connection method comprising the steps of:
receiving by the client one of the collections of data entries in the authentication database;
sending a first message carrying an identification tag from the client to the access point;
receiving by the access point a second message carrying a query tag, the second message being provided by the authentication database, the query tag being associated with a puzzle, the puzzle being associated with a first data entry of one of the collections of data entries, wherein a first answer to the puzzle is stored in the authentication database and comprises the first data entry;
sending a third message carrying the query tag from the access point to the client, the query tag being associated with the puzzle;
sending a fourth message carrying an answer tag from the client to the access point and the authentication database, the answer tag being associated with a second answer; and
comparing and determining, by the authentication database, whether the first answer and the second answer match, so as to yield a comparison result.

2. The method of claim 1, wherein the puzzle comprises an index or position of the first data entry in the collections of data entries.

3. The method of claim 1, further comprising sending, before the access point receives the second message, a message carrying a puzzle request tag from the access point to the authentication database, so as to request the second message.

4. The method of claim 1, further comprising authenticating, after the client has sent the first message, by the access point a media access control address (MAC address) of the client.

5. The method of claim 1, after the client has sent the fourth message, further comprising the steps of:
sending a message carrying a compare tag from the access point to the authentication database, so as to compare and determine whether the first answer and the second answer match; and
sending the comparison result from the authentication database to the access point.

6. The method of claim 1, wherein, in response to the comparison result being a match, further comprising the steps of:
sending the comparison result from the access point to the client; and
deleting the first data entry from the authentication database.

7. The method of claim 1, wherein a fake access point or a spy access point is blocked by a puzzle/answer protocol, wherein the authentication database is disposed at a server coupled to the access point; wherein the first message further comprises a media access control address (MAC address) of the client for authenticating a tag using the puzzle/answer protocol; wherein the second message further comprises the MAC address of the client and the MAC address of the access point; wherein the third message further comprises the MAC address of the client; wherein the fourth message further comprises the MAC address of the client.

8. The method of claim 1, wherein a query tag and the answer tag are embedded in an authentication frame having an authentication header, the authentication header having a frame body field containing the query tag and the answer tag.

9. The method of claim 1, wherein the client and the access point connect in response to the comparison result being a match, wherein the client and the access point do not connect in response to the comparison result being not a match.

10. A computer program product comprising a computer executable procedure step, the computer executable procedure performing a network connection in a wireless local area network, the wireless local area network comprising a client, an access point, and an authentication database coupled to the access point, the computer executable procedure step comprising a procedure step for executing the method of claim 1.

11. A client for accessing an access point in a wireless local area network, the wireless local area network comprising the access point, an authentication database coupled to the access point, comprising a program memory, and storing a procedure step for executing the method of claim 1, and a processor for executing a procedure step stored in the program memory.

12. An access point accessible to a client in a wireless local area network, the wireless local area network comprising the client, an authentication database coupled to the access point, comprising a program memory, and storing a procedure step for executing the method of claim 1, and a processor for executing a procedure step stored in the program memory.

13. A wireless local area network, comprising a client, an access point, and an authentication database coupled to the access point, the authentication database comprising a plurality of collections of data entries, wherein each of the collections of data entries comprises a plurality of data entries, wherein:
the client receives one of the collections of data entries of the authentication database;
the client sends a first message carrying an identification tag to the access point;
the access point receives a second message carrying a query tag associated with a puzzle, the second message being provided by the authentication database, the puzzle being associated with a first data entry of one of the collections of data entries, wherein a first answer to the puzzle is stored in the authentication database and comprises the first data entry;
the access point sends to the client a third message carrying the query tag associated with the puzzle;
the client sends to the access point and the authentication database a fourth message carrying an answer tag associated with a second answer; and
the authentication database compares and determines whether the first answer and the second answer match, so as to yield a comparison result.

14. The wireless local area network of claim 13, wherein the puzzle comprises an index or position of the first data entry in the collections of data entries.

15. The wireless local area network of claim 13, wherein, in response to the comparison result being a match, the access point sends the comparison result to the client, and the first data entry is deleted from the authentication database.
